(19) United States
(12) Patent Application Publication
(10) Pub. No.: US 2011/0208898 A1
(43) Pub. Date: Aug. 25, 2011

(54) STORAGE DEVICE, COMPUTING SYSTEM, AND DATA MANAGEMENT METHOD

(75) Inventor: Yong Shik SHIN, Hwaseong-si (KR)

(73) Assignee: SAMSUNG ELECTRONICS CO., LTD., Suwon-si (KR)

(21) Appl. No.: 13/008,424

(22) Filed: Jan. 18, 2011

(30) Foreign Application Priority Data
Feb. 23, 2010 (KR) 10-2010-0016282
Feb. 23, 2010 (KR) 10-2010-0016284

(51) Int. Cl. G06F 12/02

(52) U.S. Cl. 711/103; 711/165; 711/E12.008; 711/E12.002

(57) ABSTRACT

A data storage device receives an invalidity command, and in response to the invalidity command, records information identifying a first region of a main storage unit. In a first interval, the data storage device copies valid data from the first region of the main storage unit to a second region of the main storage unit based on the recorded information. In a second interval after the first interval, the data storage device invalidates the first region.

### CROSS-REFERENCE TO RELATED APPLICATIONS

This application claims priority under 35 U.S.C. §119 to Korean Patent Application No. 10-2010-0016282 filed on Feb. 23, 2010, and Korean Patent Application No. 10-2010-0016284 filed on Feb. 23, 2010, the respective disclosures of which are hereby incorporated by reference in their entirety.

### BACKGROUND

Embodiments of the inventive concept relate generally to electronic data storage technologies. More particularly, embodiments of the inventive concept relate to data storage devices, computing systems, and methods of managing data in the data storage devices and computing systems.

The information age has been marked by a continuing increase in the demand for digital data storage. In response to this increasing demand, researchers have continued to develop new data storage devices capable of storing larger amounts of data.

Hard disk drives (HDDs) have been a dominant technology for providing mass data storage due to various attractive characteristics, such as high recording density, high data transfer speed, fast access times, and low price. However, HDDs have a complex mechanical structure that can lead to malfunctions due to physical impacts and vibrations. Accordingly, in recent years, HDDs have been increasingly replaced by solid state drives (SSDs).

Unlike HDDs, SSDs have no mechanical parts. Accordingly, SSDs can reduce latency and other mechanical driving times, and they can also perform high-speed read and write operations. SSDs can also reduce errors caused by latency and mechanical friction, so they can improve the reliability of read and write operations. Furthermore, SSDs produce relatively little heat and noise and are resistant to external impacts, so they are especially suitable for a variety of portable devices.

### SUMMARY

Embodiments of the inventive concept provide data storage devices, computing systems, and related data management methods. Some embodiments allow memory resources to be used more efficiently. Some embodiments allow memory resources to recover effectively after an unexpected power interruption.

According to one embodiment of the inventive concept, a method is provided for managing data in a data storage device comprising a storage unit. The method comprises receiving an invalidity command comprising information indicating a first region of the storage unit to be invalidated, and recording information identifying the first region of the storage unit. In a first interval, the method copies only valid data from the first region into a second region of the storage unit based on the recorded information. In a second interval after the first interval, the method invalidates the first region.

In certain embodiments, the invalidity command comprises a secure TRIM command or a security invalidity command.

In certain embodiments, the invalidity command comprises start and end addresses of the first region.

In certain embodiments, the method further comprises determining whether a buffer contains at least a predetermined amount of available storage space, and copying the valid data from the first region to the second region as a consequence of determining that the buffer does not contain at least the predetermined amount of available storage space.

In certain embodiments, the method further comprises, upon determining that the buffer does not contain at least the predetermined amount of available storage space, determining whether the storage unit contains an empty memory block to which the valid data can be copied, and upon determining that the storage unit does not contain an empty memory block to which the valid data can be copied, erasing at least one memory block of the storage unit.

In certain embodiments, the valid data is copied into a memory block in an erased state.

In certain embodiments, the storage unit comprises at least one flash memory chip, and the first and second regions are memory blocks of the at least one flash memory chip.

In certain embodiments, the first region is marked as deleted in a file allocation table of a host.

According to another embodiment of the inventive concept, a data storage device comprises a main storage unit, and a controller that controls operation of the main storage unit. The controller receives an invalidity command from a host and records information from the invalidity command identifying a first region of the main storage unit. In a first interval, the controller copies only valid data from the first region into a second region of the main storage unit based on the recorded information. In a second interval after the first interval, the controller invalidates the first region.

In certain embodiments, the controller performs an erase operation on the first region during the second interval.

In certain embodiments, the main storage unit comprises a flash memory device and the first and second regions are memory blocks of the flash memory device.

In certain embodiments, the data storage device further comprises a buffer for recording the information identifying the first region of the main storage unit, and the controller determines an amount of available storage space in the buffer before recording the information identifying the first region of the main storage unit, and upon determining that the amount is less than a predetermined value, flushes the buffer before recording the information identifying the first region of the main storage unit.

In certain embodiments, the controller stores pivot data indicating a state of the erase operation, and upon rebooting after an unexpected power interruption, resumes the erase operation from the state indicated by the pivot data.

According to another embodiment of the inventive concept, a method is provided for managing data in a data storage device comprising a main storage unit. The method comprises receiving an invalidity command, and in response to the invalidity command, recording information identifying a first region of the main storage unit. The method further comprises initiating a purge operation to erase the first region based on the recorded information, storing pivot data indicating a state of the purge operation, and resuming the purge operation, after a power interruption, from the state indicated by the pivot data.

In certain embodiments, the pivot data is stored in a nonvolatile memory.

In certain embodiments, the purge operation purges multiple units of data, and pivot data is stored each time purging is performed on one of the units.

In certain embodiments, the purge operation purges multiple units of data, and pivot data is stored each time purging is performed on a predetermined number of the units.

In certain embodiments, storing the pivot data comprises storing progress information regarding the purge operation by page or block unit.

In certain embodiments, the main storage unit comprises a flash memory device.

In certain embodiments, the pivot data is stored at periodic intervals of time.

### BRIEF DESCRIPTION OF THE DRAWINGS

The drawings illustrate selected embodiments of the inventive concept. In the drawings, like reference numbers indicate like features.

FIG. 1 is a diagram illustrating a computing system according to an embodiment of the inventive concept.

FIG. 2 is a diagram illustrating an example of a controller shown in FIG. 1 according to an embodiment of the inventive concept.

FIG. 3 is a diagram illustrating another example of the controller shown in FIG. 1 according to an embodiment of the inventive concept.

FIG. 4 is a flowchart illustrating a method of performing an invalidity operation in a computing system according to an embodiment of the inventive concept.

FIGS. 5 through 7 are diagrams illustrating a first-type merge operation that can be used in an invalidity operation according to an embodiment of the inventive concept.

FIGS. 8 through 14 are diagrams illustrating a second-type merge operation that can be used in an invalidity operation according to an embodiment of the inventive concept.

FIG. 15 is a diagram illustrating a computing system according to an embodiment of the inventive concept.

FIG. 16 is a flowchart illustrating a method of performing an invalidity operation in a computing system according to an embodiment of the inventive concept.

FIG. 17 is a diagram illustrating a purge operation in the method of FIG. 16.

FIG. 18 is a diagram illustrating a memory system according to an embodiment of the inventive concept.

FIG. 19 is a diagram illustrating a computing system according to an embodiment of the inventive concept.

### DETAILED DESCRIPTION OF EMBODIMENTS

Embodiments of the inventive concept are described below with reference to the accompanying drawings. These embodiments are presented as teaching examples and should not be construed to limit the scope of the inventive concept.

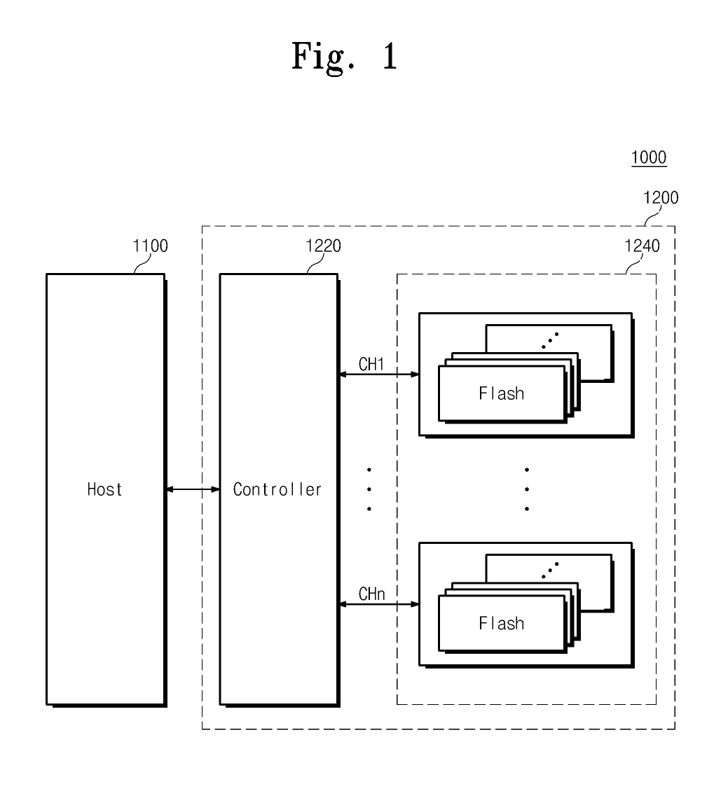

FIG. 1 is a diagram illustrating a computing system 1000 according to an embodiment of the inventive concept.

Referring to FIG. 1, computing system 1000 comprises a host 1100 and a storage device 1200. Host 1100 is configured to control storage device 1200. In certain embodiments, host 1100 comprises a portable electronic device such as a personal computer, a PDA, a PMP, or an MP3 player.

When deleting stored data from storage device 1200, host 1100 invalidates metadata related to the stored data. Host 1100 then notifies storage device 1200 that the stored data is invalid. This can be accomplished by transmitting an invalidity command to storage device 1200. An invalidity command typically comprises information for designating a region to be deleted, such as address information of the region. Certain types of invalidity commands include a file delete command, a TRIM command, an unwrite command, and a deletion command.

A file system of host 1100, such as FAT, can be used to process metadata for a file to be deleted. To improve the performance of computing system 1000, the file system typically marks a file as deleted before it is actually deleted. This can be accomplished, for instance, by replacing the first letter of a corresponding filename with a special code in the file system. For example, the file system can replace the first letter of the filename with a hexadecimal byte code “E6h”.

After the file system invalidates metadata of a file to be deleted, the contents of the file may still be indicated as valid in storage device 1200. Accordingly, the file system of host 1100 provides an invalidity command, such as a TRIM command, to storage device 1200 to invalidate the contents of the invalidated file in storage device 1200.

The invalidity command can be classified as a normal invalidity command for invalidating normal data, or a security invalidity command for invalidating data requiring security, referred to as security data. One type of security invalidity command is a secure TRIM command. The security invalidity command causes security data deleted by host 1100 to be completely removed from storage device 1200. The security invalidity command can also be used to delete data other than security data.

In certain embodiments described below, a security invalidity command is presented as an example of an invalidity command. However, these and other embodiments can be modified to use other types of invalidity commands.

In certain embodiments, storage device 1200 comprises an SSD. However, storage device 1200 can take other forms. In addition, storage device 1200 can be integrated into various types of devices, such as a personal computer memory card international association (PCMCIA) card, a compact flash (CF) card, a smart media card (SMC or SM), a memory stick, a multi media card (MMC, RS-MMC, or MMCmicro), an SD card (SD, miniSD, microSD, or SDHC), or a universal flash memory system (UFS).

Storage device 1200 comprises a controller 1220 and a main storage unit 1240. Controller 1220 controls main storage unit 1240 in response to requests from host 1100. Controller 1220 is connected to main storage unit 1240 through a plurality of channels CH1 through CHn.

Main storage unit 1240 comprises a plurality of flash memories connected to channels CH1 through CHn. These flash memories can be single level cell (SLC) flash memories, multi-level cell (MLC) flash memories, or a combination of SLC flash memories and MLC flash memories. In some embodiments, main storage unit 1240 comprises other types of nonvolatile memory such as PRAM, FRAM, or MRAM, or volatile memory such as DRAM or SRAM. Main storage unit 1240 can also comprise both nonvolatile and volatile memory.

Computing system 1000 performs a security invalidity operation using two steps: “step 1” and “step 2”. In the description that follows, the security invalidity operation may be referred to as an invalidity operation and a corresponding security invalidity command may be referred to as an invalidity command.

In step 1, host 1100 provides the invalidity command to storage device 1200. In response to the invalidity command, storage device 1200 records position information of data to be deleted according to the invalidity command. The recorded information is typically stored in controller 1220 or main storage unit 1240. The operation of recording the position information of data to be deleted according to an invalidity command is called logging, and the information associated with logging is referred to as logging information.

Next, storage device 1200 notifies host 1100 that execution of the requested invalidity command is completed. As a result, host 1100 behaves as if execution of the invalidity command is completed and treats data corresponding to the invalidity command as invalid. Step 1 can be repeated an arbitrary number of times for different data stored in storage device 1200.

Step 2 deletes or purges data identified by the logging information of step 1. In some embodiments, step 2 is performed during an idle time of storage device 1200, which can occur much later than step 1. This can improve the response time of host 1100 and can improve the performance of storage device 1200 or computing system 1000.

The logging information of a region or files to be deleted can be stored in a RAM, a buffer, a register of controller 1220, or main storage unit 1240. The logging information of invalid files recorded in step 1 can be recorded or managed using a bitmap structure.

As the number of repetitions of step 1 increases, the size of the bitmap structure tends to increase accordingly. The RAM or buffer must be sufficiently large to accommodate the bitmap structure. An increase in the bitmap size can also require an increase in the amount of space required to store management data in the RAM or buffer. This can be a burden for a RAM or a buffer having a limited capacity.

Moreover, valid data and invalid data co-exist in main storage unit 1240 before step 2 is completed. Consequently, the number of free blocks in main storage unit 1240 tends to decrease with the number of executions of step 1. Accordingly, step 1 is limited by the capacity of the RAM or buffer and the capacity of main storage unit 1240. Additionally, in a read operation, host 1100 must check information in the bitmap to determine whether read data is invalid, which can slow down read operations.

To address the above limitations, storage device 1200 can perform step 1 using an alternative method that is less affected by the capacity of the RAM, the buffer, or main storage unit 1240. For instance, storage device 1200 can perform a selective merge operation to copy valid data from a region having invalid data into a new memory block. The new memory block to which copying is performed can be an empty memory block in an erased state.

In the merge operation, invalid data remains in the initial region without being copied to the new memory block. Accordingly, the new memory block stores data having an erased state, e.g., “1111 . . . ” or “0xFF . . . ” instead of the invalid data. Step 1 can be repeated any number of times, as long as sufficient space is retained in the RAM, the buffer, or main storage unit 1240.

The selective merge operation can reduce the amount of logging information that must be stored in the RAM, the buffer, or main storage unit 1240. It can also allow host 1100 to perform read operations without additional processes for determining whether read data is invalid. It can also allow the RAM, buffer, or main storage unit 1240 to operate more effectively with a limited data storage capacity.

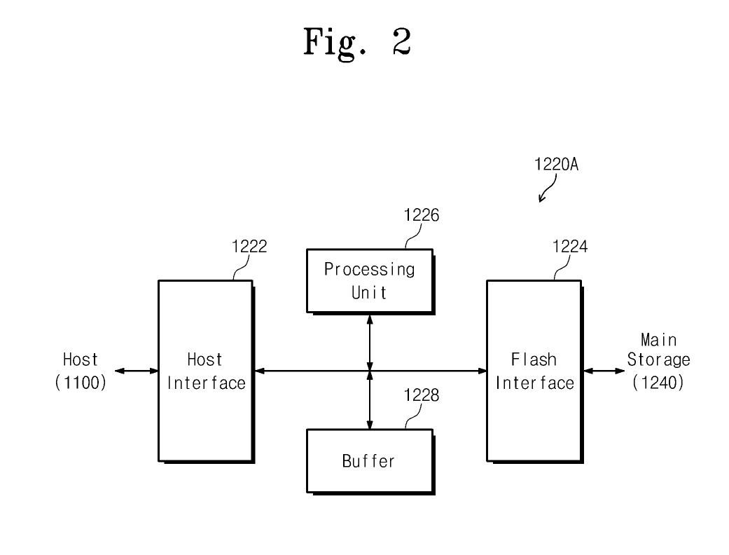

FIG. 2 is a diagram illustrating a controller 1220A according to an embodiment of the inventive concept. Controller 1220A is an example of controller 1220 of FIG. 1. Where storage device 1200 is an SSD, controller 1220A comprises an SSD controller.

Controller 1220A comprises a host interface 1222, a flash interface 1224, a processing unit 1226, and a buffer memory 1228. The configuration of controller 1220A can be modified in various ways, such as adding an error correction circuit for detecting and correcting errors in data stored in main storage unit 1240.

Host interface 1222 provides an interface with a host 1100, and flash interface 1224 provides an interface with main storage unit 1240. Processing unit 1226 controls operations of controller 1220A.

Buffer memory 1228 temporarily stores data to be programmed in main storage unit 1240 or data read from main storage unit 1240. Buffer memory 1228 can also be used to store logging information for a region to be deleted according to an invalidity command. Buffer memory 1228 typically comprises a volatile memory such as a DRAM or SRAM. In some embodiments, logging information is stored using an additional volatile or nonvolatile memory or a register instead of buffer memory 1228.

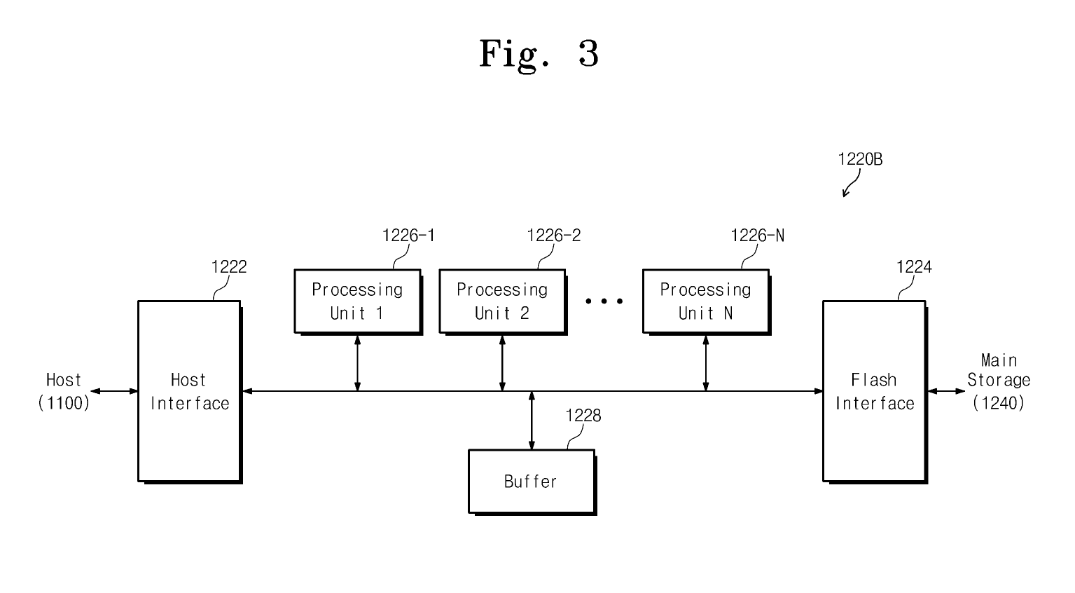

FIG. 3 is a diagram illustrating a controller 1220B according to an embodiment of the inventive concept. Controller 1220B is another example of controller 1220 of FIG. 1. Where storage device 1200 is an SSD, controller 1220B comprises an SSD controller.

Controller 1220B comprises a host interface 1222, a flash interface 1224, a plurality of processing units 1226_1 through 1226_N, and a buffer memory 1228. Because controller 1220B comprises processing units 1226_1 through 1226_N, it can be referred to as a multi-core processor. In contrast, controller 1220A, which comprises one processing unit 1226, can be referred to as a single core processor.

Controller 1220B controls operations of storage device 1200 through processing units 1226_1 through 1226_N. Controller 1220B divides a plurality of control operations and allocates the divided control operations to processing units 1226_1 through 1226_N. The plurality of control operations are then performed in parallel.

In certain embodiments, processing units 1226_1 through 1226_N correspond to respective channels CH1 through CHn and are configured to control each channel separately. In such embodiments, even where controller 1220B is driven by a low frequency clock, it can provide relatively high throughput due to parallel operations.

Controller 1220B can be modified in various ways, such as adding an error correction circuit for detecting and correcting errors in data stored in main storage unit 1240.

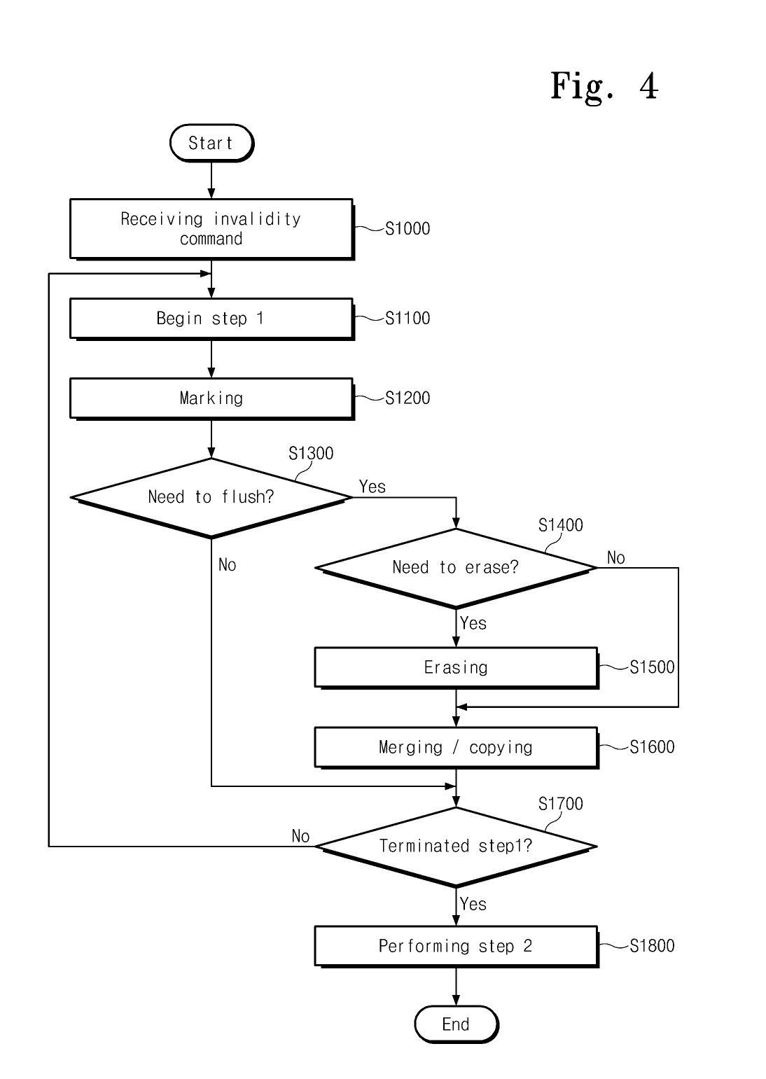

FIG. 4 is a flowchart illustrating a method of performing an invalidity operation in computing system 1000 according to an embodiment of the inventive concept. In the description that follows, example method steps are indicated by parentheses.

Referring to FIG. 4, storage device 1200 receives an invalidity command from host 1100 (S1000). The invalidity command is used to delete files having invalid contents from storage device 1200. In the example of FIG. 4, the invalidity command is a security invalidity command and comprises information representing a region of files with invalid contents. The information representing a region of files with invalid contents typically comprises start and end addresses of the region.

Step 1 is initiated in response to the invalidity command (S1100). Then, controller 1220 records or marks position information of a region or files to be deleted in response to the invalidity command (S1200). The position information is typically recorded in a RAM, a buffer, a register of controller 1220, or main storage unit 1240.

Controller 1220 generates a response signal (e.g., an ACK signal) after the position information is recorded. The response signal notifies host 1100 that execution of the invalidity command is completed. As a result, host 1100 operates as if execution of the invalidity command is completed and a region to be deleted is actually deleted.

Host 1100 can recognize a region as being deleted in main storage unit 1240 according to a mapping table that stores a mapping between physical blocks and logical blocks of main storage unit 1240. Accordingly, the region can be marked as deleted by removing or marking the region in the mapping table.

In main storage unit 1240, address management of flash memory chips is performed by system software executed by SSD controller 1220 or a flash translation layer (FTL) implemented by firmware. The FTL can be used to map logical block addresses (LBAs) generated by the file system of host 1100 into physical block addresses (PBAs). This address mapping allows host 1100 to communicate with storage device 1200 as if it were a HDD or an SRAM. This address mapping can be performed using a mapping table managed by the FTL. In the method of FIG. 4, FTL functions can be performed in operation S1200.

After operation S1200, controller 1220 determines whether a buffer memory should be flushed in response to the invalidity command (S1300). This determination can be made according to the number of executions of step 1, or whether available space in the buffer memory is greater than a predetermined size. For instance, in some embodiments, the flush operation of the buffer memory is performed after step 1 is performed more than a predetermined number of times, or where available space in the buffer memory is less than a predetermined size. In other embodiments, different conditions can be used to determine whether to execute a flush operation. In the flush operation, data is flushed out of the buffer memory and stored in the flash memory.

Where the buffer memory is to be flushed (S1300=Yes), the method determines whether an erase operation needs to be performed in the flash memory (S1400) to accommodate the flushed data or to prepare for a subsequent merge operation. This determination can be made, for instance, according to whether the flash memory contains an empty memory block. Where the erase operation needs to be performed in the flash memory (S1400=Yes), the erase operation is performed on at least one memory block (S1500). Otherwise, (S1400=No), the method proceeds to operation S1600. The FTL can identify the memory block to be erased in operation S1500. The FTL can also manage erase information of the memory block after it has been erased. The erased memory block can be marked with information representing an erased state.

After the erase operation, a merge operation is performed on valid data based on a result of the recording performed in operation S1200 (S1600). The merge operation can be performed using a variety of methods. A first-type merge operation and a second-type merge operation are described below.

The first-type merge operation can be used where host 1100 invalidates data stored in a flash memory. In the first-type merge operation, valid data is latched inside the flash memory and is not required to be output from the flash memory. As an example, the first-type merge operation can be performed using a copy-back operation.

The second-type merge operation can be used where host 1100 invalidates data stored in the buffer memory. In the second-type merge operation, based on a result of the recording operation of operation S1200, only valid data is flushed from the buffer to the flash memory through the flush operation. Invalid data included in a region marked as being invalid is not copied into the flash memory.

In the first and second-type merge operations, invalid data included in a region marked invalid is excluded from a merge operation. As a result, invalid data has the same effect as if a value of “1111 . . . ” or “0xFF . . . ” were copied to a target location. By excluding data from the merge operation, the time required for the merge operation is reduced.

Because a merge operation is performed in step 1, host 1100 can read data from storage device 1200 without confirming information of all blocks in a bitmap. Also, the size of a bitmap storing logging information is reduced. Accordingly, overhead due to bitmap management is reduced and storage space in a RAM, a buffer, or main storage unit 1240 can be used more efficiently.

Following operation S1600, the method determines whether step 1 is completed (S1700). Where step 1 is completed (S1700=Yes), step 2 is performed (S1800). Otherwise (S1700=No), the method returns to operation S1100. In some embodiments, operation S1800 is performed during an idle time of storage device 1200.

In operation S1800, invalid data in a region marked as being invalid in operation S1200 is purged from the buffer memory or the flash memory. This purge operation can also be referred to as a confidential erase operation. In the confidential erase operation, invalid data is completely erased to make recovery impossible. This confidential erase operation can be useful for removing confidential data.

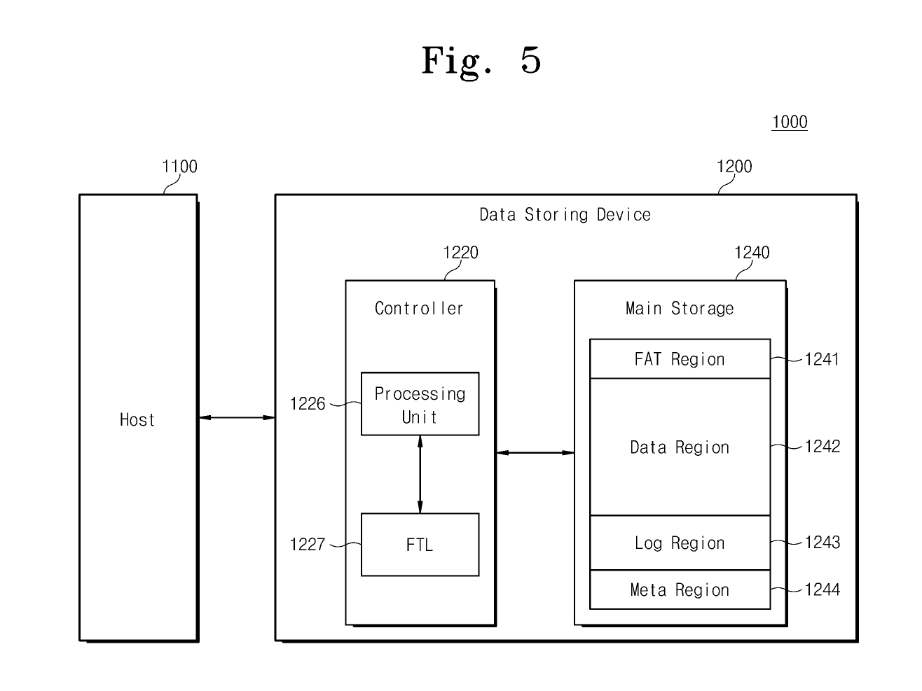

FIGS. 5 through 7 are diagrams illustrating an example of the first-type merge operation. The first-type merge operation is performed when host 1100 invalidates data stored in a flash memory of storage device 1200. In the first-type merge operation, memory block marked invalid is selectively copied into an empty memory block. The first-type merge operation is performed using file system information.

In the example of FIG. 5, main storage unit 1240 comprises a flash memory. The flash memory comprises a cell array comprising a plurality of memory blocks. Each of the memory blocks comprises a plurality of cell strings. A page of data is accessed by selecting memory cells connected to the same wordline. Main storage unit 1240 performs erase operations in memory block units, and performs read and write operations in page units. In other embodiments, read and write operations can be performed using other units.

Address management for main storage unit 1240 is performed by an FTL. Based on the FTL, host 1100 recognizes storage device 1200 as a storage medium in which read, write, and erase operations are performed similar to an HDD.

Main storage unit 1240 comprises a FAT region 1241, a data region 1242, a log region 1243, and a meta region 1244.

FAT region 1241 stores file system information. Log region 1243 comprises log blocks corresponding to memory blocks of data region 1242. Where data is to be written into a memory block of data region 1242, the data is stored in a log block of log region 1243 rather than being directly written into the memory block. However, where no log block is designated for a memory block of data region 1242, a merge operation can be performed to store the data in a memory block of data region 1242. A merge operation can also be performed where there is no space in a log block designated for the memory block, or where a request for a merge operation is received from host 1100. Also, where an invalidity command is received from host 1100, a merge operation can be performed on a recorded region where a predetermined condition is satisfied. The predetermined condition can be, for instance, a detected number of executions of step 1, or a detected amount of available space in the buffer memory.

In certain embodiments, a valid page of a log block or a valid page of a memory block are copied into a new log block or memory block or through a merge operation during step 1. Where the merge operation is performed, mapping information is changed and stored in meta region 1244.

Controller 1220 controls main storage unit 1240 in response to access requests made by host 1100. Controller 1220 comprises a processing unit 1226 and a work memory 1227. Work memory 1227 stores the FTL.

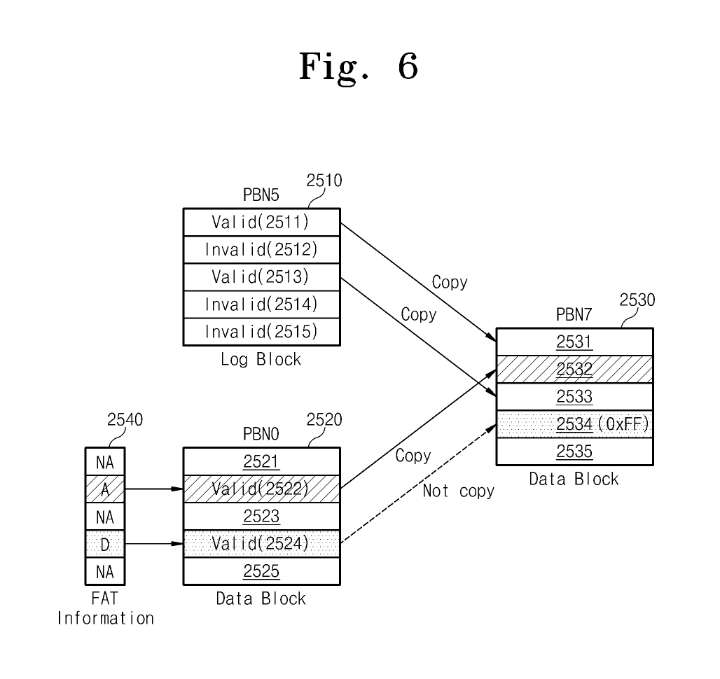

FIG. 6 is a diagram illustrating a first-type merge operation. The first-type merge operation of FIG. 6 is performed in computing system 1000 using file system information. The file system information indicates whether to invalidate a memory block of storage device 1200.

Referring to FIG. 6, valid pages 2511 and 2513 of a log block 2510 and a valid page 2522 of a memory block 2520 are merged into a new memory block 2530. More specifically, first and third pages 2511 and 2513 of log block 2510 are copied into respective first and third pages 2513 and 2533 of new memory block 2530, and second page 2522 of memory block 2520 is copied into second page 2532 of new memory block 2530. Data “1111 . . . ” is already recorded on fourth page 2534 of new memory block 2530 corresponding to invalid fourth page 2524 of memory block 2520. Accordingly, the first-type merge operation does not write data into fourth page 2534.

The first-type merge operation selectively copies valid pages of memory block 2520 into new memory block 2530 with reference to FAT information 2540 recorded in step 1 of the method of FIG. 4. Memory block 2530 is initially empty.

FAT information 2540 indicates whether a page of memory block 2520 is allocated. For example, first, third, and fifth pages 2521, 2523, and 2525 of memory block 2520 are not used to store a file, so they are indicated as not allocated (NA) in FAT information 2540. Second page 2522 of memory block 2520 is a valid page storing a file, so it is indicated as allocated (A) in FAT information 2540.

Fourth page 2524 of memory block 2520 is designated as a region to be invalidated according to an invalidity command input from host 1100, so it is indicated as deleted (D) in FAT information 2540. However, fourth page 2524 is still indicated as a valid page in memory block 2520. Consequently, data stored in fourth page 2524 of memory block 2520 is indicated as valid page in the FTL, but is indicated as invalid in the file system. From the perspective of host 1100, the data stored in fourth page 2524 of memory block 2520 is invalid.

Where fourth page 2524 of memory block 2520 is indicated as deleted in FAT information 2540, the data in fourth page 2524 is not copied into new memory block 2530 in the first-type merge operation. As a result, the merge operation has the effect of copying the invalid data with a value of “1111 . . . ” or “0xFF . . . ”.

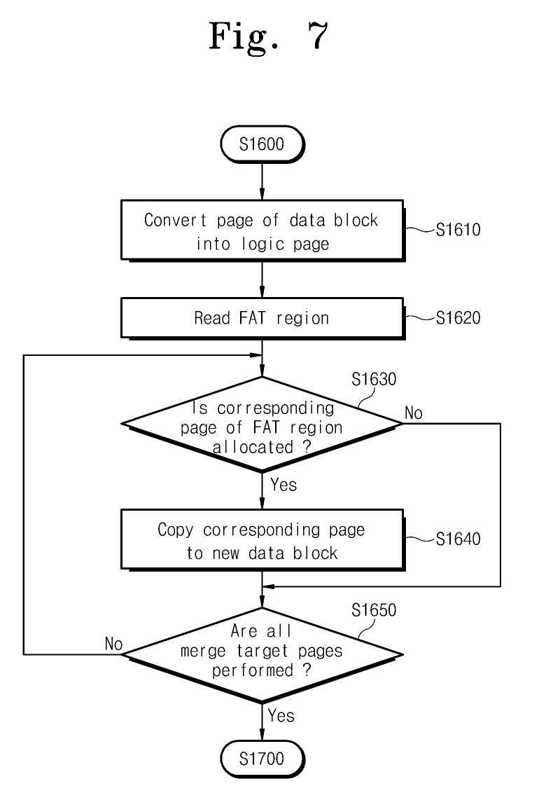

FIG. 7 is a flowchart illustrating a first-type merge operation according to an embodiment of the inventive concept. In the embodiment of FIG. 7, the first-type merge operation is performed in computing system 1000 of FIG. 5.

Referring to FIG. 7, the FTL of storage device 1200 maps a new logical address onto a page of new memory block 2530 (S1610). Then, controller 1220 reads FAT information from FAT region 1241 of storage device 1240 (S1620) and determines, based on the FAT information, whether a selected page of a memory block is a valid (S1630). In particular, controller 1220 determines whether the selected page is allocated to store a file. Where the page is not allocated (NA) or is marked deleted (D) (S1630=No), the method proceeds to operation S1650 without copying data from the selected page into the new memory block. Otherwise (S1630), the method proceeds to operation S1640.

Where the selected page is a valid page (A) storing a file, data in the selected page is copied into the new memory block (S1640). Operations S1630 and S1640 are then performed on remaining pages of the memory block (S1650). After operations S1630 and S1640 have been performed on all pages of the memory block, page copy operations are performed on a log block, and the merge operation is terminated.

Because the first-type merge operation does not copy invalid data to the new memory block, the first-type merge operation can reduce the amount of time to perform merging in step 1. For example, where the number of valid pages in a log block is “x”, the total number of pages storing data in a memory block is “y”, and a time required to copy one page is “z”, a total time required for a merge operation is (x+y)*z. Where the number of deleted pages identified by the file system is “i”, the merge operation spends (i*z) units of time on unnecessary copying. Accordingly, the first-type merge operation can reduce the time of a merge operation by i*z minus the time required to read the FAT region.

Where a predetermined condition is satisfied, the first-type merge operation is performed in step 1. The condition can be, for instance, completion of a predetermined number of executions of step 1, whether sufficient storage space is available in a buffer memory or a main storage unit, or whether a flush operation is to be executed. In some embodiments, the first-type merge operation is configured to be performed regardless of whether a flush operation is performed. In such embodiments, an operation for determining whether to execute a flush operation can be selectively omitted from first-type merge operation.

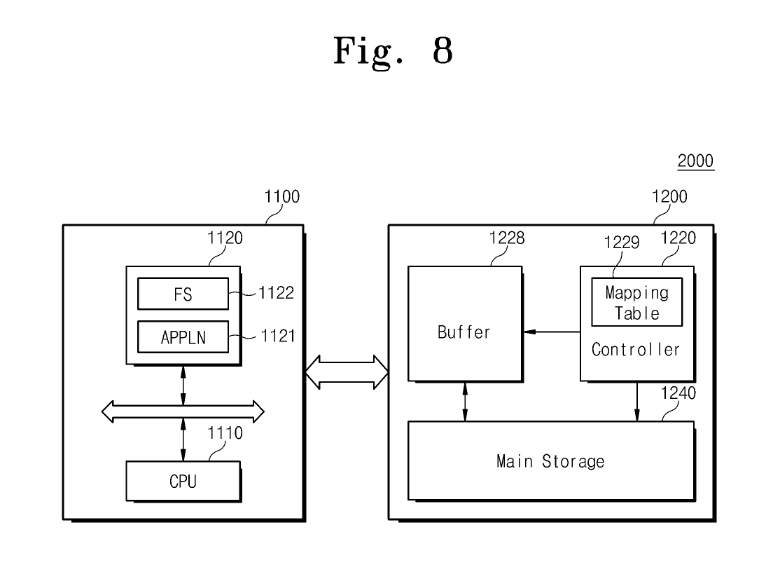

FIGS. 8 through 14 are diagrams illustrating an example of the second-type merge operation. In the second-type merge operation of FIGS. 8 through 14, a flash memory stores data that has been invalidated by host 1100, and valid data in a region marked invalid is selectively copied from a buffer memory into an empty memory block.

Referring to FIG. 8, a computing system 2000 comprises host 1100 and storage device 1200. Host 1100 comprises a central processing unit (CPU) 1110 and a memory 1120. At least a part of memory 1120 serves as a main memory of host 1100.

An application program 1121 and a file system 1122 are stored in memory 1120. In the embodiment of FIG. 8, file system 1122 uses a file allocation table (FAT). However, file system 1122 can have other configurations in alternative embodiments.

Where some or all of file data processed by application program 1121 is deleted, CPU 1110 provides an invalidity command to storage device 1200. CPU 1110 also transmits address information and size information for the data to be deleted to storage device 1200.

The FAT file system comprises a master boot record (MBR), a partition boot record (PBR), first and second file allocation tables such as primary FAT and copy FAT, and a root directory. Files stored or to be stored in storage device 1200 are confirmed based a file name and a path of a directory tree passed to reach a position where a file is stored.

In one directory, each entry comprises information such as a 32-byte length, a file name, an extension, a file property byte, last-changed date or time, a file size, and connection to startup cluster. A special code is used as the first letter of the file name for indicating a deleted file. For example, E5h of a hexadecimal byte code can be placed on the first letter of the file name to indicate to the system that the file has been deleted. Where a file is deleted, CPU 1110 places the special code as the first letter of a corresponding file name and outputs an invalidity command (or, invalidity information about deleted file data) to storage device 1200.

Storage device 1200 comprises a main storage unit 1240, a buffer memory 1228, and a controller 1220. Main storage unit 1240 can be used to store various types of data, such as document data, image data, music data, and program data. Main storage unit 1240 comprises a nonvolatile memory such as a flash memory. However, main storage unit 1240 is not limited thereto and can have various other forms.

Buffer memory 1228 is used to facilitate efficient data transfer between host 1100 and main storage unit 1240 and typically comprises a high-speed volatile memory such as DRAM or SRAM, or a nonvolatile memory such as MRAM, PRAM, FRAM, NAND flash memory, and NOR flash memory.

Buffer memory 1228 operates as a write buffer for storing data to be written in main storage unit 1240 in response to a request from host 1100. In some instances, however, data delivered from host 1100 can be directly transmitted to main storage unit 1240 without passing through buffer memory 1228. Such direct transmissions are referred to as write bypass.

Buffer memory 1228 also operates as a read buffer for storing data read from main storage unit 1240 in response to a request from host 1100. Although only one buffer memory is shown in the drawings, more than two buffer memories can be provided. Each buffer memory can be used as a write buffer, a read buffer, or a read buffer and a write buffer.

Controller 1220 controls main storage unit 1240 and buffer memory 1228. In response to a read command from host 1100, controller 1220 controls main storage unit 1240 to transfer data from main storage unit 1240 to host 1100, or controller 1220 controls main storage unit 1240 and buffer memory 1228 to transfer data stored in main storage unit 1240 to host 1100 through buffer memory 1228.

Where a write command is input from host 1100, controller 1220 temporarily stores data related to the write command in buffer memory 1228. Some or all of the data that is temporarily stored in buffer memory 1228 is transferred to main storage unit 1240 under the control of controller 1220 where the available space of buffer memory 1228 is insufficient during a normal operation or during an idle time.

Upon receiving invalidity information from an external source, storage device 1200 marks corresponding data as invalid in a region of buffer memory 1228 or main storage unit 1240. This marking operation can be performed during step 1. Then, during step 1, based on the marking, valid data in a region marked as being invalid is selectively merged into an empty memory block of main storage unit 1240.

The second-type merge operation can be performed using a flush operation of buffer memory 1228, and can prevent data deleted in an upper level of storage device 1200 from being written from buffer memory 1240 into main storage unit 1240.

The second-type merge operation can be performed according to the number of executions of step 1 or an amount of space for storing data in the buffer memory. In some embodiments, the flush operation of the buffer memory is performed where step 1 is performed more than a predetermined number of times or each time step 1 is performed. In some embodiments, the buffer memory is flushed if the available space for storing data in the buffer memory is greater than a predetermined size. In various alternative embodiments, the buffer memory can be flushed according to other conditions.

Controller 1220 comprises a mapping table 1229 for storing address mapping information between main storage unit 1240 and buffer memory 1228 and write state information indicating whether data stored in buffer memory 1228 is valid.

The write state information is updated according to invalidity information provided from an external source, as will be discussed below. Controller 1220 controls main storage unit 1240 and buffer memory 1228 to write some or all of the data stored in buffer memory 1228 into main storage unit 1240 according to the write state information of mapping table 1229.

Storage device 1200 marks a region to be invalid during step 1 in response to an invalidity command, and performs a merge operation for transferring some or all of the data stored in buffer memory 1228 into main storage unit 1240 according to the marking result and the write state information of mapping table 1229. The merge operation prevents the data deleted already in an upper level of storage device 1200 from being written from buffer memory 1240 into main storage unit 1240.

Storage device 1200 receives invalidity information representing whether data stored in the buffer memory is valid from the external source and prevents the invalid data among the data stored in buffer memory 1228 from being written in main storage unit 1240 based on the received information. This can improve write performance of storage device 1200, increase the lifetime of main storage unit 1240, and reduce power consumption due to unnecessary write operations.

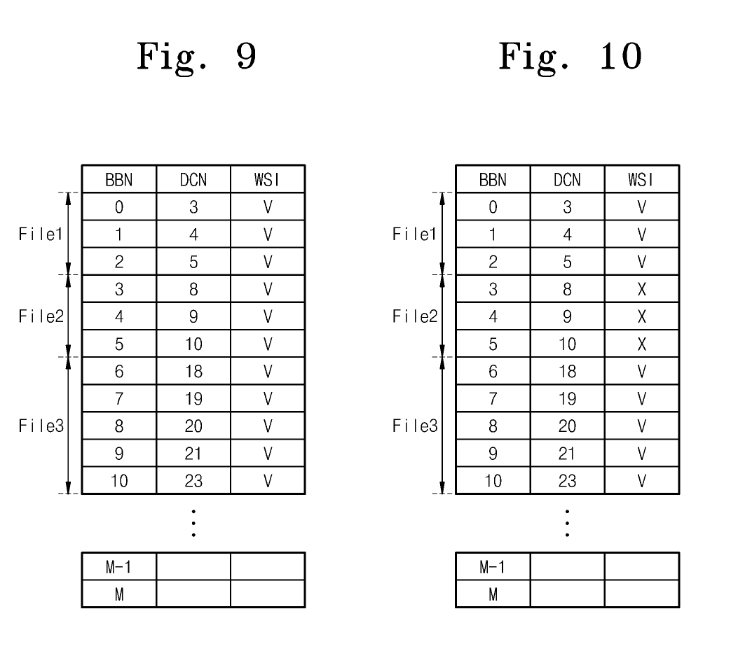

FIGS. 9 and 10 are diagrams illustrating a configuration of mapping table 1229 of controller 1220 in FIG. 8.

Referring to FIGS. 9 and 10, a symbol BBN represents a block number of buffer memory 1228 and a symbol DCN represents a cluster number of main storage unit 1240. A symbol WSI represents write state information indicating whether data stored in buffer memory 1228 is valid data.

For convenience of description, it is assumed that a block size of buffer memory 1228 is identical to that of a cluster comprising a plurality of sectors. However, an allocation unit of main storage unit 1240 is not limited thereto. For example, an allocation unit of main storage unit 1240 can be designated as a section of a magnetic disk, or a page, a sector, or a block of a flash memory. In FIGS. 9 and 10, invalid data is represented with X and valid data is represented with V.

As shown in FIG. 9, it is assumed that data related to three files FILET, FILE2, and FILE3 are stored as valid data in buffer memory 1228. Each unit of data read from main storage unit 1240 can be updated by host 1100 without immediately being stored in main storage unit 1240. Each unit of data can be delivered from host 1100 to buffer memory 1228 without immediately being stored in main storage unit 1240.

The file data FILE1, FILE2, AND FILE3 stored in buffer memory 1228 is transferred into main storage unit 1240 under the control of controller 1220 during the second-type merge operation. Controller 1220 can be configured to update write state information of the file data FILE1, FILE2, AND FILE3 according to invalidity information delivered from host 1100. For example, where host 1100 inputs invalidity information indicating that the file data FILE2 is deleted from host 1100 in an upper level of storage device 1200, controller 1220 marks write state information of file data FILE2 as invalid, as indicated by an X in FIG. 10. Controller 1220 can also represent write state information of data written in main storage unit 1240 with an X to indicate invalid data.

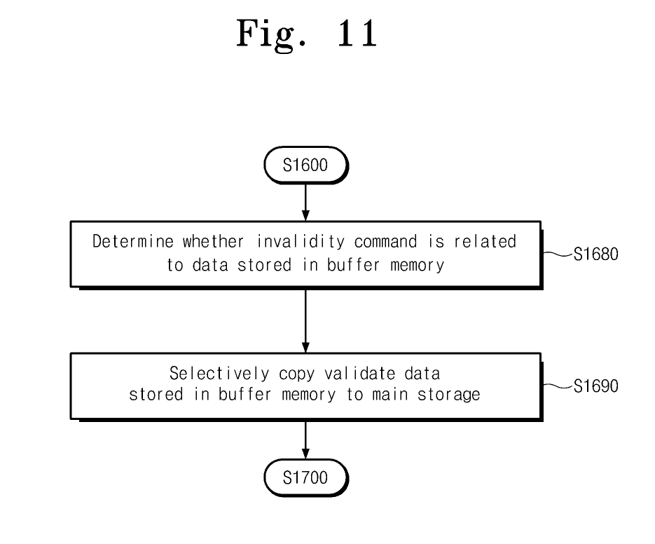

FIG. 11 is a flowchart illustrating an example of the second-type merge operation. In FIG. 11, the merge operation is performed using buffer memory 1228 of computing system 2000.

Referring to FIG. 11, it is determined whether an invalidity command input from host 1100 is related to data stored in buffer memory 1228 (S1680). Where an invalidity command input from host 1100 is related to data stored in buffer memory 1228, valid data stored in buffer memory 1228 is selectively copied into main storage unit 1240 (S1690). In operation S1690, data that has already been deleted in an upper level of storage device 1200 is prevented from being copied from buffer memory 1228 into main storage unit 1240. Accordingly, invalid data that has already been deleted in an upper level of storage device 1200 has the same effect as if data of “1111 . . . ” or “0xFF . . . ” were copied.

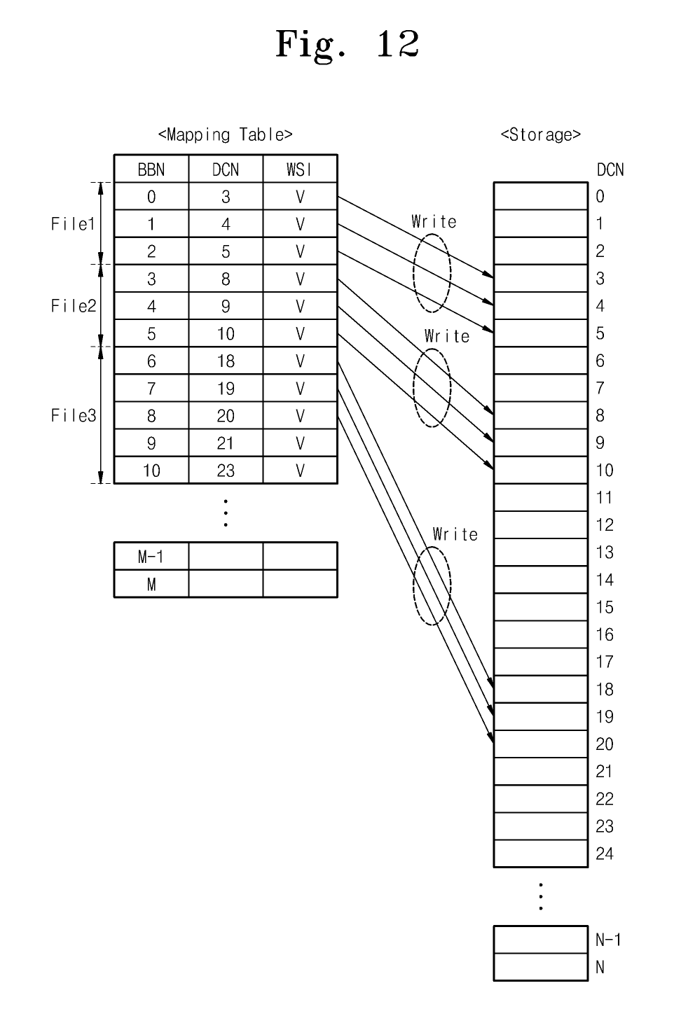

FIGS. 12 through 14 are diagrams illustrating examples of the second-type merge operation. In FIGS. 12 through 14, a selective merge operation is performed using buffer memory 1228 of computing system 2000.

In the example of FIG. 12, three file data FILE1 through FILE3 are stored as valid data in buffer memory 1228. At a specific point, controller 1220 of storage device 1200 determines which data is invalid data according to write state information WSI of mapping table 1229 related to the stored file data FILE1 through FILE3.

Because all of file data FILE1 through FILE3 is shown as valid data in mapping table 1229 of FIG. 12, controller 1220 controls main storage unit 1240 and buffer memory 1228 to transfer file data FILE1 through FILE3 to an empty memory block of main storage unit 1240.

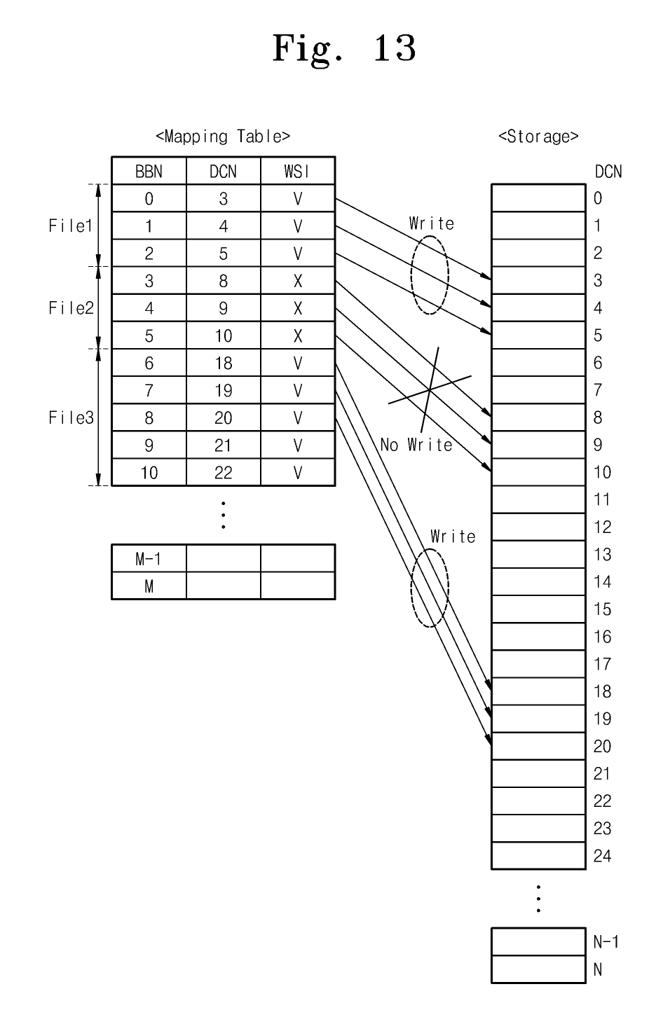

Referring to FIG. 13, where invalidity information (e.g., an invalidity command, address information of an invalid data file, and size information of invalid file data) from host 1100 is input before an operation for transferring and writing data in main storage unit 1240, controller 1220 marks file data related to the invalidity information as being invalid in step 1. For example, write state information WSI of mapping table 1229 related to the file data FILE2 can be updated by a control of controller 1220 to represent invalid data in response to the invalidity information from host 1100.

Then, at a specific point (e.g., where a flush operation is required), controller 1220 of storage device 1200 determines which data files are invalid with reference to write state information WSI of mapping table 1229 related to the stored file data FILE1 through FILE3.

Where a flush operation is required in step 1, controller 1220 performs a merge operation on file data marked valid. For example, in mapping table 1229, only file data FILE1 and FILE3 are marked as being valid. Accordingly, in the merge operation, controller 1220 controls main storage unit 1240 and buffer memory 1228 to selectively transfer only the file data FILE1 and FILE3 into a corresponding space of main storage unit 1240. Controller 1220 prevents file data FILE2 from being transferred into a corresponding space of main storage unit 1240. A space of buffer memory 1228 processed into invalid file data can be used for a write or read operation performed later.

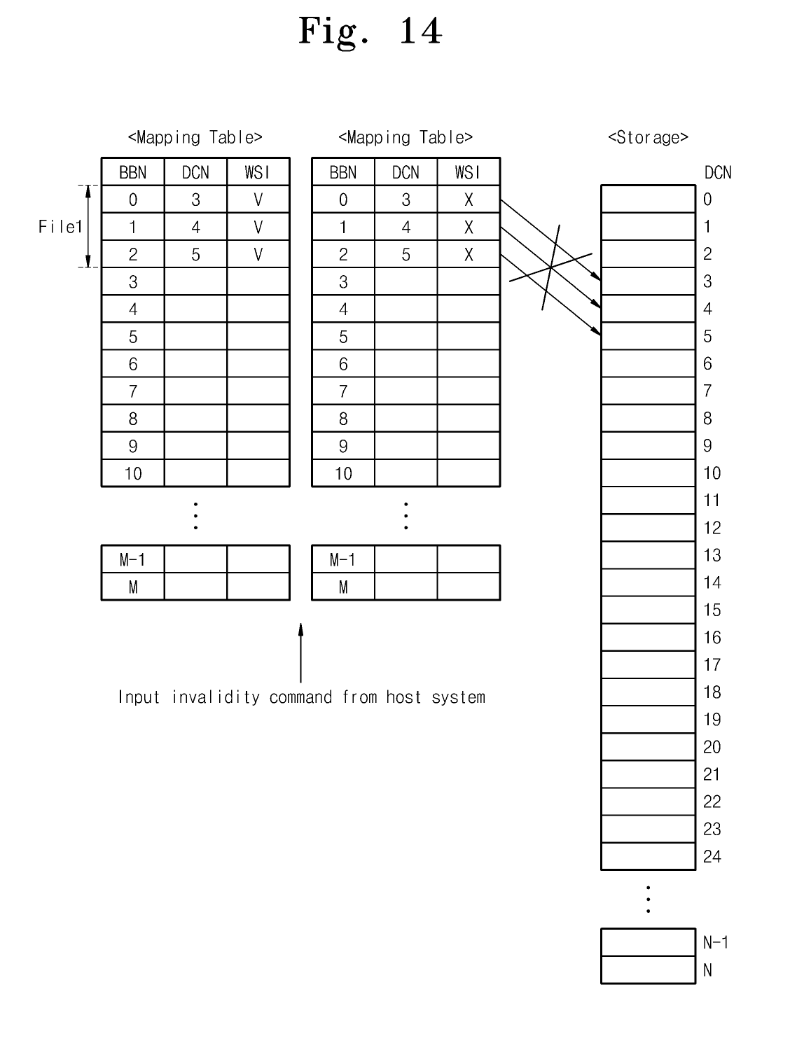

In another example, illustrated in FIG. 14, only one file data FILE1 is stored in buffer memory 1228. Where an invalidity command is input from host 1100 before an operation for transferring and writing data into main storage unit 1240, controller 1220 marks data FILE1 related to the input invalidity command as invalid data during step 1.

Accordingly, data FILE1 is shown as being invalid to host 1100. Write state information WSI of mapping table 1229 related to data FILE1 is updated to represent invalid data under the control of controller 1220. Later, at a specific point (e.g., where a flush operation is required), controller 1220 determines whether the stored data is invalid data with reference to write state information WSI of mapping table 1229 related to the stored data FILE1.

After invalid data is marked in step 1, there is no data represented as valid data in mapping table 1229. Accordingly, no transfer write operation occurs between buffer memory 1228 and main storage unit 1240 in storage device 1200. As a result, a transfer write operation of the invalid data is prevented. A space of buffer memory 1228 marked as invalid data can be used for a write operation performed later.

In some embodiments, the first and second-type merge operations are performed as “don't care”, meaning that they are performed independent of whether data is valid from the perspective of host 1100. In such embodiments, data marked invalid in buffer memory 1228 is selectively transferred into main storage unit 1240 under the control of controller 1220. Although data indicated as invalid is copied into main storage unit 1240, files related to invalid data stored in main storage unit 1240 are not affected.

In some embodiments, where the first and second-type merge operations are performed as don't care, a memory block to be a target of a merge operation maintains an empty space in only a region corresponding to valid data. Accordingly, during the merge operation, an entire memory block is not in an erase state, but only a region corresponding to valid data is maintained in the erase state. According to this configuration, more flexible data allocation is possible and a data empty storage capacity of main storage unit 1240 can be adequately utilized. Moreover, during the merge operation, an operation erasing a block to be a target of the merge operation can be selectively omitted.

The flash memory device may confront a situation where rebooting is required due to a fatal error during an operation. As one example, an unexpected power interruption can require rebooting. Where an unexpected power interruption occurs during a data invalidation operation, a corresponding invalidation operation needs to resume after the flash memory is rebooted.

To reduce execution time of a data invalidation operation resumed after the unexpected power interruption, storage device 1200 can store pivot data in main storage unit 1240 at each purge operation where data of a region recorded as an invalid file during step 1 is purged during step 2. The pivot data can be configured in a pivot table in main storage unit 1240. Storage and management about the pivot data can be performed by system software executed by controller 1220 or an FTL.

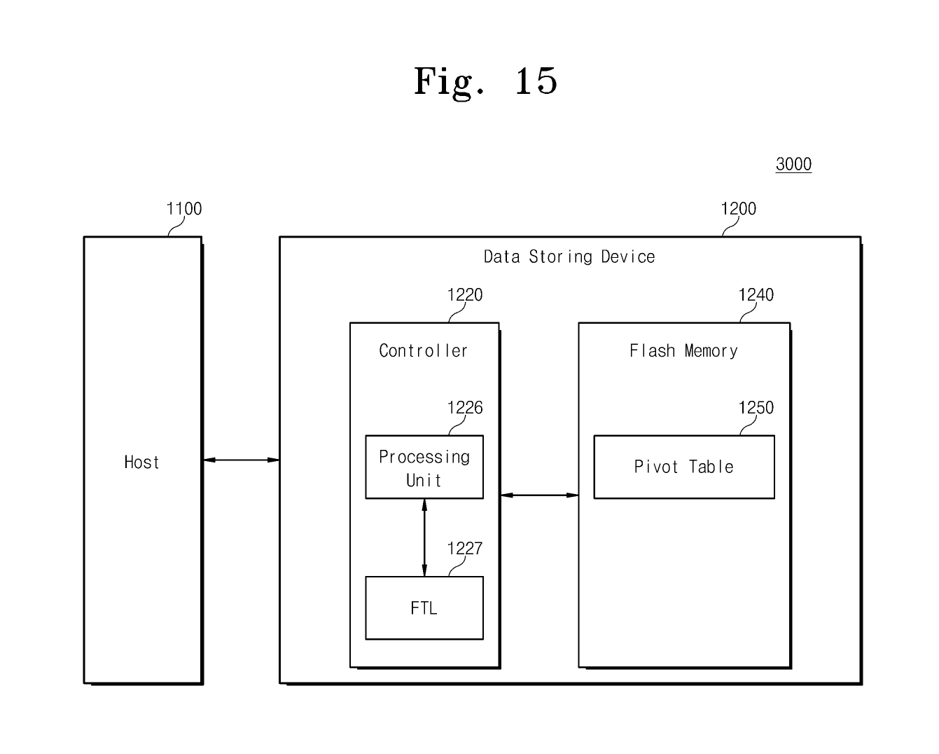

A data invalidation operation using pivot data will be described in further detail with reference to FIGS. 15 through 17.

FIG. 15 is a diagram illustrating a configuration of computing system 3000 that performs a data invalidation operation.

Referring to FIG. 15, computing system 3000 comprises host 1100 and storage device 1200. Storage device 1200 comprises main storage unit 1240 and controller 1220.

Where an invalidity command is input from host 1100, a region to be invalidated is marked during step 1. In this example, the invalidity command comprises a secure invalidity command, such as a secure TRIM command. Data of a region recorded as an invalid file during step 1 is purged during step 2.

Storage device 1200 stores pivot data during data invalidation operations in order to more efficiently resume data invalidation operations after an unexpected power interruption. For example, storage device 1200 may store pivot data in main storage unit 1240 at each purge operation performed during step 2. The pivot data can be configured in a pivot table 1250 in main storage unit 1240. Storage and management operations of pivot data in pivot table 1250 can be performed by an FTL.

In some embodiments, the pivot data indicates whether each step of an invalidation operation is completed. The pivot data can indicate a merge result of step 1 by a page or block unit, and a purging result of step 2 by a block unit. The pivot data can be stored at a predetermined time or as needed. This stored pivot data can be loaded from main storage unit 1240 into controller 1220 during a rebooting operation. The pivot data is not limited to a specific storage format, but can be configured in various forms.

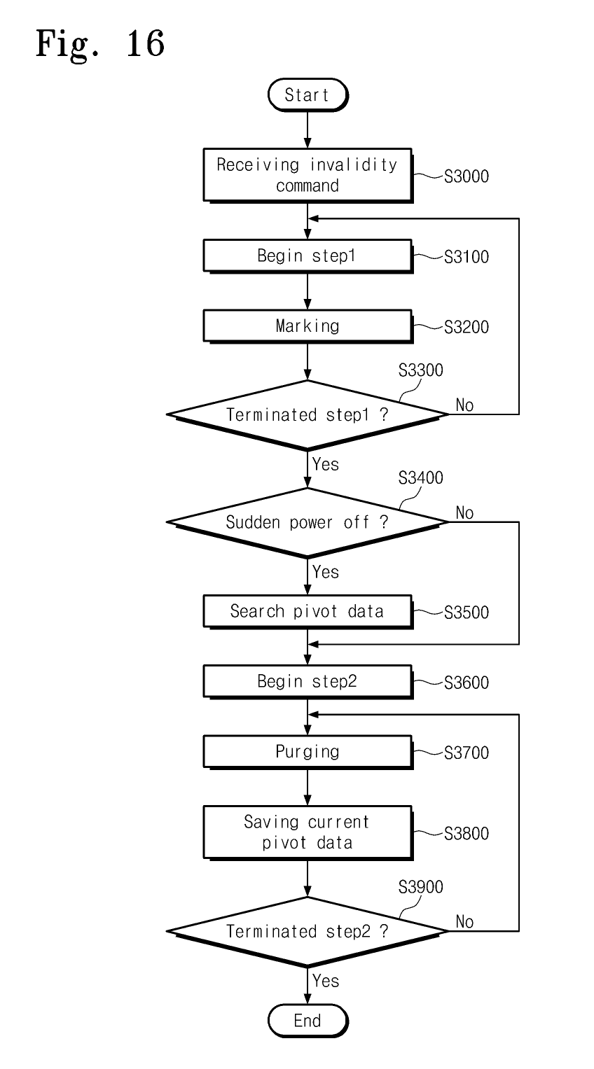

FIG. 16 is a flowchart illustrating a method of performing an invalidity operation in computing system 3000 according to an embodiment of the inventive concept.

Referring to FIG. 16, storage device 1200 receives an invalidity command from host 1100 (S3000) and initiates step 1 (S3100). The invalidity command can be used for deleting invalid files from storage device 1200. In the example of FIG. 16, the invalidity command is a secure invalidity command comprising information representing a region of files having invalid contents. The information representing the region of files having invalid contents comprises start and end addresses of a region to be invalidated.

Following initiation of step 1, controller 1220 records position information of a region (or files) to be invalidated in response to an invalidity command provided from host 1100 (S3200). In some embodiments, file system information is used to indicate whether a memory block is invalidated. The file system information can have a format such as FAT, HPFS, NTFS, UFS, FFS, MMFS, or VFAT. In other embodiments, non-file system information is used to indicate whether a memory block is invalidated.

The information recorded in operation S3200 is typically stored in a RAM, a buffer, a register in controller 1220, or in main storage unit 1240. Controller 1220 transmits a response signal (e.g., an ACK signal) to host 1100 after recording position information of a region (or files) to be invalidated. Upon receiving the response signal from storage device 1200, host 1100 recognizes the invalidity command as being completed. At this point, data in a region to be deleted is recognized as invalid from the perspective of host 1100. This invalidity can be represented by a mapping table where mapping between physical blocks and logical blocks of main storage unit 1240 is recorded. Data can be marked invalid, for example, removing mapping information about the region to be deleted from the mapping table or marking the region to be deleted in the mapping table.

The above-described invalidity can be selectively achieved through an operation in which information representing an invalid block is recorded in a memory block of main storage unit 1240. The invalidity can also be achieved through an operation in which information representing an invalid block is recorded in a memory block of main storage unit 1240 corresponding to a region to be deleted. Address management during a write or erase operation of main storage unit 1240 can be performed by system software executed by controller 1220 or an FTL.

Next, the method determines whether step 1 is completed (S3300). Where step 1 is not completed (S3300=No), the method returns to operation S3100 and step 1 is repeated. Otherwise (S3300=Yes), the method determines whether an unexpected power interruption has occurred (S3400).

Where an unexpected power interruption has occurred (S3400=Yes), previously-stored pivot data is searched (S3500). Otherwise (S3400=No), the method proceeds to operation S3600. Next, step 2 is initiated (S3600). In certain embodiments, operation S3600 is performed during an idle time of storage device 1200 where a command is not received from host 1100.

Next, invalid data included in a region marked invalid in operation S3200 is purged from a buffer memory or a flash memory (S3700). A purge operation performed in operation S3700 comprises an operation for merging valid data from a region of main storage unit 1240 to be invalidated into a new memory block and an operation for completely removing data from the region to be invalidated. The operation for completely removing the invalid data is a confidential erase operation. In the confidential erase operation, invalid data is completely erased to make recovery impossible. The confidential erase operation can be useful for a secure invalidity operation.

Where an unexpected power interruption has occurred previously, the purge operation of operation S3700 is executed from a prior stopping point using pivot data identified in operation S3500. Accordingly, the purge operation can be performed without purging regions that have already been purged. Accordingly, the time required for the purge operation can be reduced following an unexpected loss of power.

Moreover, where the unexpected loss of power has not occurred previously, the purge operation performed in operation S3700 is sequentially executed based on the information recorded in operation S3200, and operation S3500 can be omitted.

A merge operation performed in the purge operation of operation S3700 can be executed in various ways. For example, the merge operation can be executed using file system information (e.g., FAT, HPFS, NTFS, UFS, FFS, MMFS, and VFAT, etc.). Valid data read for the merge operation is not output from flash memory, and can be merged in the flash memory in a latched state using a copy-back operation. During the merge operation, invalid data is not copied from a region to be invalidated, which can reduce the amount of time required to perform the merge operation.

Pivot data for each step of a currently-progressing purge operation is stored in main storage unit 1240 (S3800). In some embodiments, the pivot data is stored in a meta region of main storage unit 1240 comprising a nonvolatile memory such as a flash memory. Accordingly, where power is suddenly interrupted, the pivot data is retained and can be used in subsequent purge operations. Where the power is suddenly interrupted during step 2 of an invalidity operation, the pivot data can be provided to controller 1220 during a subsequent booting operation of storage device 1200.

The timing and method of storing the pivot data can be variously modified. For example, the timing of storing the pivot data can be determined according to the number of executions of step 2 or a size of data used for performing step 2. In some embodiments, the pivot data is stored each time step 2 is performed, after a predetermined number of repetitions of step 2. Alternatively, pivot data can be stored each time the amount of data to be processed in step 2 is greater or less than a predetermined size.

After the pivot data is stored, the method determines whether step 2 is completed (S3900). Where step 2 is not completed (S3900=No), the method returns to operation S3700. Otherwise (S3900=Yes), the invalidity operation is completed.

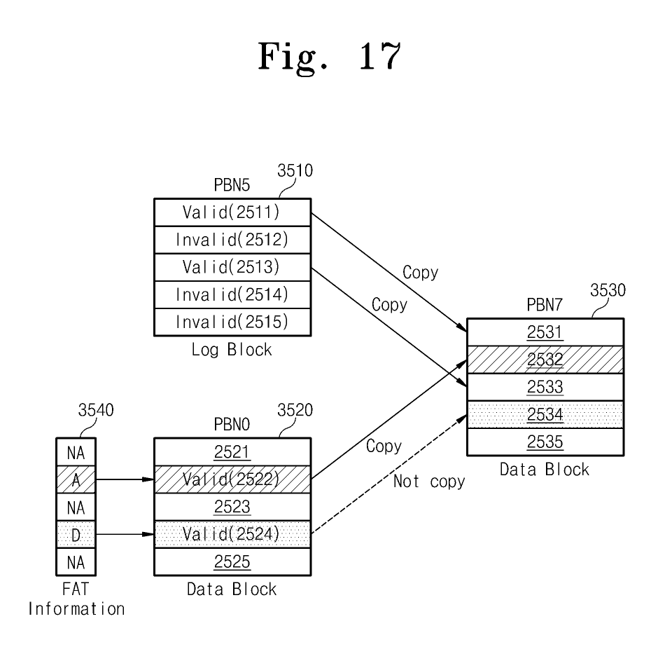

FIG. 17 is a diagram illustrating an example of purge operation S3700 shown in FIG. 16. In the example of FIG. 17, it is assumed that the purge operation is performed in a file system such as FAT, HPFS, NTFS, UFS, FFS, MMFS, or VFAT. Moreover, the purge operation is performed in a flash memory.

The purge operation of FIG. 17 comprises an operation for merging or copying valid data from a region of main storage unit 1240 to be invalidated into a new memory block of main storage unit 1240 and an operation for removing invalid data from the invalidated region. By removing the invalid data, the purge operation prevents the invalid data from being accessed by an external device.

Referring to FIG. 17, storage device 1200 performs the purge operation using a result recorded in step 1. The purge operation comprises an operation for merging or copying valid data in a region to be invalidated into the new memory block and an operation for removing invalid data from the region to be invalidated. Storage device 1200 periodically stores pivot data for each step of a currently-progressing delete or purge operation during the purge operation. The pivot data can be stored in main storage unit 1240 comprising a nonvolatile memory such as a flash memory.

As shown in FIG. 17, valid pages 3511 and 3513 of a log block 3510 and a valid page 3522 of a memory block 3520 are merged into a new memory block 3530 through a merge operation during step 2.

Where an unexpected power interruption occurs in storage device 1200 during an invalidity operation, a merge operation for valid data performed during step 2 and a delete operation for invalid data are controlled according to an analysis of pivot data stored before the unexpected power interruption. For example, storage device 1200 can analyze a progressing state of a purge operation by searching the previously-stored pivot data when rebooting. Moreover, based on the analysis, a data invalidation operation can be performed from a point where the power interruption occurred, preventing redundant operations and reducing the time required to complete the purge operation.

As an example, where an unexpected power interruption occurs during a merge operation performed on the first and third pages 3511 and 3513 of log block 3510 based on the analysis of the pivot data, a data invalidation operation can be performed from a merge operation for first and third pages 3511 and 3513 after storage device 1200 is rebooted. In this case, the first and third pages 3511 and 3513 of log block 3510 marked valid are copied into first and third pages 3531 and 3533 of new memory block 3530, respectively. Moreover, second page 3522 of memory block 3520 marked valid is coped into second page 3532 of new memory block 3530.

Fourth page 3524 of memory block 3520 marked invalid is not copied into second page 3532 of new memory block 3530 because only valid pages of memory block 3520 are copied into new memory block 3530 during step 2 with reference to information (e.g., FAT information 3540) recorded during step 1.

FAT information 3540 stored in main storage unit 1240 indicates whether a page of memory block 3520 is allocated. For example, first page 3532 of memory block 3520 is not used for storing a file and is indicated as not allocated (NA) in FAT information 3540. Second page 3522 of memory block 3520 is a valid page storing a file and is indicated as allocated (A) in FAT information 3540. Third and fifth pages 3523 and 3535 of memory block 3520 are also indicated as NA in FAT information 3540.

Where fourth page 3524 of memory block 3520 is designated as a region to be invalidated according to an invalidity command from host 1100, fourth page 3534 is marked as deleted (D) in FAT information 3540. Accordingly, fourth page 3534 is deemed to be deleted from the perspective of host 1100 even though it remains a valid page from the perspective of an FTL.

Accordingly, during a merge operation, data in fourth page 3524 is not copied into new memory block 3530. As a result, a fourth page 2534 of new memory block 3430, which corresponds to fourth page 2524, stores a value 0xFF corresponding to an erased state.

Moreover, where invalid data is processed as “don't care” (i.e., irrespective of whether the data is invalid from the perspective of host 1100), the data marked invalid in buffer memory 1228 is selectively transferred into main storage unit 1240 under the control of controller 1220. In this case, although data indicated as invalid data is copied into main storage unit 1240, files related to invalid data stored in main storage unit 1240 are not affected.

In the first and second-type merge operations, where invalid data is processed as “don't care”, a target memory block a merge operation can be configured to maintain empty space in only a region corresponding to valid data. In other words, because the merge operation is not performed on invalid data, even if an entire memory block is not in an erase state, only a region corresponding to valid data needs to be in an erase state. In this configuration, more flexible data allocation is possible and available storage capacity of main storage unit 1240 can be efficiently used. Moreover, in the merge operation, an operation for erasing a target memory block to be a target of the merge operation can be selectively omitted.

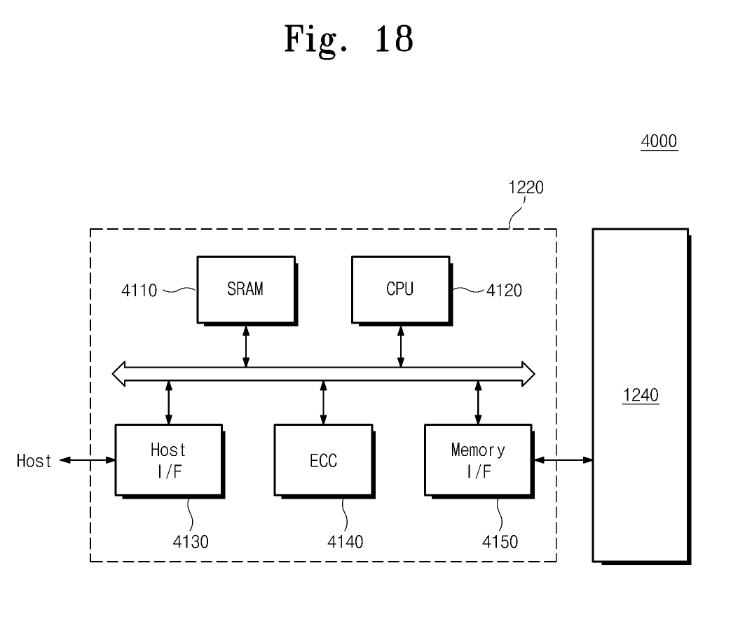

FIG. 18 is a diagram illustrating a memory system 4000 according to an embodiment of the inventive concept.

Referring to FIG. 18, system 4000 comprises controller 1220 and main storage unit 1240. Main storage unit 1240 can be implemented as shown in one of FIGS. 1, 5, 8, and 15. Additionally, memory system 4000 can implement one of the invalidation operations illustrated in FIGS. 4 and 16.

Controller 1220 is configured to control main storage unit 1240 and can be implemented as shown in one of FIGS. 1, 2, 5, 8, and 15.

SRAM 4110 is used as a working memory of a CPU 4120. A host interface 4130 implements a data exchange protocol of a host connected to memory system 4000. An error correction circuit 4140 in controller 1220 detects and corrects errors in data read from main storage unit 1240. A memory interface 4150 interfaces with main storage unit 1240. CPU 4120 performs general control operations for data exchange of controller 1220. Memory system 4000 can further comprise a ROM storing code data for interfacing with the host.

Main storage unit 1240 can be provided as a multi-chip package comprising a plurality of flash memory chips. Memory system 4000 can be configured in a variety of forms, such as an SSD. In an SSD, controller 1220 can serve as a memory controller to communicate with external devices through one of various interface protocols such as USB, MMC, PCI-E, SAS, SATA, PATA, SCSI, ESDI, and IDE. Controller 1220 can further comprise features for controlling a data invalidation operation for invalidating data deleted in the host.

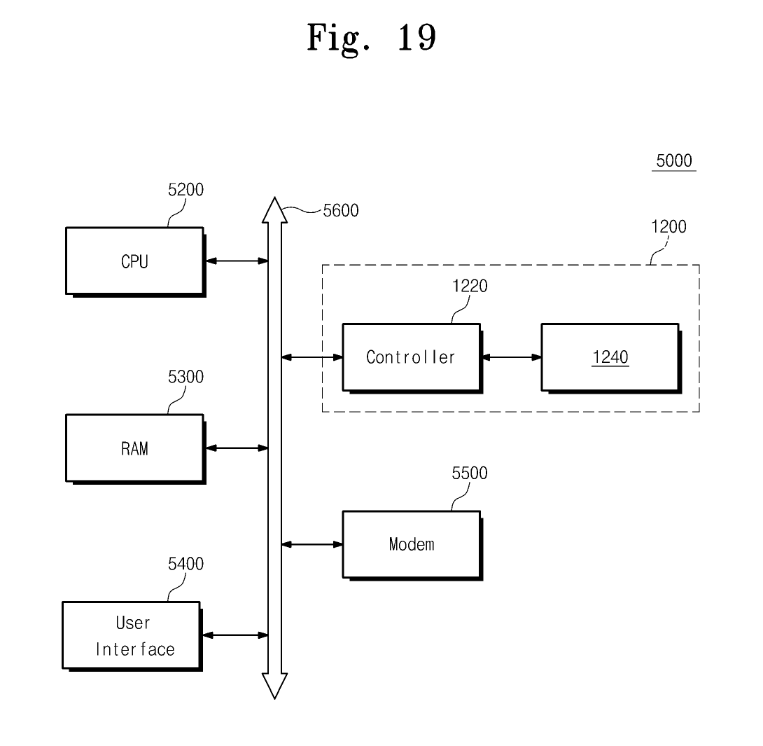

FIG. 19 is a diagram illustrating a computing system 5000 according to an embodiment of the inventive concept.

Referring to FIG. 19, computing system 5000 comprises a CPU 5200, a RAM 5300, a user interface 5400, a modem 5500 such as a baseband chipset, and storage device 1200, which are electrically connected to a system bus 5600.

Storage device 1200 comprises controller 1220 and main storage unit 1240. Controller 1220 provides a physical connection between CPU 5200 and main storage unit 1240 through system bus 5600. Controller 1220 provides an interface with main storage unit 1240 according to a bus format of CPU 5200.

Main storage unit 1240 can be implemented as shown in one of FIGS. 1, 5, 8, and 15. Additionally, memory system 4000 can implement one of the invalidation operations illustrated in FIGS. 4 and 16.

Where computing system 5000 is a mobile device, a battery can be additionally provided to supply an operating voltage of computing system 5000. Although not shown in the drawings, an application chipset, a camera image processor (CIS), and a mobile DRAM can be further provided in computing system 5000.

In some embodiments, computing system 5000 comprises an SSD using a nonvolatile memory to store data. In such embodiments, storage device 1200 can form the SSD and controller 1220 can operate as an SSD controller.

The above-described nonvolatile memory devices and memory controllers can be mounted in various types of packages. Examples of such package types or package configurations include package on package (PoP), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSOP), thin small outline package (TSOP), system in package (SIP), multi chip package (MCP), wafer-level fabricated package (WFP), and wafer-level processed stack package (WSP).

As indicated by the foregoing, certain embodiments of the inventive concept can improve the performance of computer systems and storage devices by allowing them to manage data more effectively in invalidity operations. Certain embodiments can also improve the performance of computer systems and storage devices after power interruptions by allowing them to purge data based on previous operations.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of managing data in a data storage device comprising a storage unit, the method comprising:
receiving an invalidity command comprising information indicating a first region of the storage unit to be invalidated;
recording information identifying the first region of the storage unit;
in a first interval, copying only valid data from the first region into a second region of the storage unit based on the recorded information; and
in a second interval after the first interval, invalidating the first region.

2. The method of claim 1, wherein the invalidity command comprises a secure TRIM command or a security invalidity command.

3. The method of claim 1, wherein the invalidity command comprises start and end addresses of the first region.

4. The method of claim 1, further comprising:
determining whether a buffer contains at least a predetermined amount of available storage space; and
copying the valid data from the first region to the second region as a consequence of determining that the buffer does not contain at least the predetermined amount of available storage space.

5. The method of claim 4, further comprising:
upon determining that the buffer does not contain at least the predetermined amount of available storage space, determining whether the storage unit contains an empty memory block to which the valid data can be copied; and
upon determining that the storage unit does not contain an empty memory block to which the valid data can be copied, erasing at least one memory block of the storage unit.

6. The method of claim 4, wherein the valid data is copied into a memory block in an erased state.

7. The method of claim 4, wherein the storage unit comprises at least one flash memory chip, and the first and second regions are memory blocks of the at least one flash memory chip.

8. The method of claim 1, wherein the first region is marked as deleted in a file allocation table of a host.

9. A data storage device, comprising:
a main storage unit; and
a controller that controls operation of the main storage unit,
wherein the controller:
receives an invalidity command from a host;
records information from the invalidity command identifying a first region of the main storage unit;
in a first interval, copies only valid data from the first region into a second region of the main storage unit based on the recorded information; and
in a second interval after the first interval, invalidates the first region.

10. The data storage device of claim 9, wherein the controller performs an erase operation on the first region during the second interval.

11. The data storage device of claim 9, wherein the main storage unit comprises a flash memory device and the first and second regions are memory blocks of the flash memory device.

12. The data storage device of claim 9, further comprising a buffer for recording the information identifying the first region of the main storage unit,
wherein the controller determines an amount of available storage space in the buffer before recording the information identifying the first region of the main storage unit, and upon determining that the amount is less than a predetermined value, flushes the buffer before recording the information identifying the first region of the main storage unit.

13. The data storage device of claim 10, wherein the controller stores pivot data indicating a state of the erase operation, and upon rebooting after an unexpected power interruption, resumes the erase operation from the state indicated by the pivot data.

14. A method of managing data in a data storage device comprising a main storage unit, the method comprising:
receiving an invalidity command;
in response to the invalidity command, recording information identifying a first region of the main storage unit;
initiating a purge operation to erase the first region based on the recorded information;
storing pivot data indicating a state of the purge operation; and
resuming the purge operation, after a power interruption, from the state indicated by the pivot data.

15. The method of claim 14, wherein the pivot data is stored in a nonvolatile memory.

16. The method of claim 14, wherein the purge operation purges multiple units of data, and pivot data is stored each time purging is performed on one of the units.

17. The method of claim 14, wherein the purge operation purges multiple units of data, and pivot data is stored each time purging is performed on a predetermined number of the units.

18. The method of claim 14, wherein storing the pivot data comprises storing progress information regarding the purge operation by page or block unit.

19. The method of claim 14, wherein the main storage unit comprises a flash memory device.

20. The method of claim 14, wherein the pivot data is stored at periodic intervals of time.
